(19) United States
(12) Patent Application Publication
(10) Pub. No.: US 2015/0100324 A1
(43) Pub. Date: Apr. 9, 2015

(54) AUDIO ENCODER PERFORMANCE FOR MIRACAST

(71) Applicant: NVIDIA Corporation, Santa Clara, CA (US)

(72) Inventors: Nikesh OSWAL, Pune (IN); Vinayak WAGLE, Kothrud (IN)

(73) Assignee: NVIDIA Corporation, Santa Clara, CA (US)

(21) Appl. No.: 14/046,866

(22) Filed: Oct. 4, 2013

(51) Int. Cl. G10L 19/008; G06F 3/16

(52) U.S. Cl. CPC G10L 19/008; G06F 3/165
USPC 704/500

(57) ABSTRACT

A method for encoding audio comprises receiving an unencoded audio signal and monitoring a user interface for user interface events. The method continues by selecting one of a plurality of transform windows to hold a defined quantity of audio samples based upon a detected one or more user interface interaction events and associated transient information. The plurality of transform windows comprises a long window sequence comprising a single window with a first quantity of samples, and a short window sequence comprising a plurality of second windows each comprising a second quantity of samples. A sum of samples of the plurality of second windows equals the first plurality of samples. The short window sequence is selected when a particular user interface interaction event is received from the user interface.

### TECHNICAL FIELD

The present disclosure relates generally to the field of multimedia content mirroring between devices and more specifically to the field of real-time audio encoding of an audio stream for multimedia content mirroring.

### BACKGROUND

The growth of multimedia content has provided consumers with an increasingly rich variety of audio and/or video content to enjoy. The advent of mobile computing has also provided the consumer with a variety of new ways to access and enjoy that same multimedia content. For example, multimedia content may now be accessed from the Internet using a variety of mobile devices, such as smart phones, tablets, and laptop computers, in addition to more traditional devices, such as televisions, desktop computer systems, disc players, and game consoles. While a more conventional television may provide a more visually appealing display of multimedia content, a mobile device may be a more convenient way to access and store the same multimedia content for later playback.

A variety of new technologies are allowing consumers to take advantage of a better viewing experience provided by a device more suited to viewing multimedia content, such as provided by a large screen television, even when the multimedia content they wish to view is only accessible on a portable device. Multimedia mirroring technologies, such as Miracast™, take advantage of the fact that many of these same portable computing devices, as well as many of the more traditional devices, are equipped to join WiFi® networks. As described herein, a Miracast enabled device, such as a tablet or smart phone, is able to stream or download multimedia content that is simultaneously mirrored to a Miracast enabled television. In other words, multimedia content played on a tablet or smartphone, for example, may be simultaneously mirrored to a large screen television.

As illustrated in FIG. 1, Miracast provides multimedia content mirroring by streaming real-time audio and video content on a WiFi wireless network from one Miracast capable device to a second Miracast capable device. As illustrated in FIG. 1, a variety of portable computing devices 102a-102n (e.g., smart phones, tablets, and laptops) may mirror or stream whatever multimedia content they are currently playing to another Miracast capable device 104a-104n (e.g., a television, desktop computer, video disc player, and game console) via a WiFi wireless network 106. Accordingly, as illustrated in FIG. 1, one or more Miracast capable devices may stream multimedia content via the WiFi wireless network 106 to one or more Miracast capable devices. This way, video games or local multimedia content may be played on a local device, while simultaneously streaming the associated audio/video data to a large screen television.

As illustrated in FIG. 2, a conventional process for implementing multimedia content streaming or mirroring, begins with step 202 of FIG. 2, where locally played raw (e.g., uncompressed) audio and video data are captured from audio and video sub-systems, respectively, of the originating local device. Thereafter, in step 204 of FIG. 2, the captured audio and video data is encoded in a supported format. For example, a Miracast supported format may be H.264 for video and AAC for audio. Next, in step 206 of FIG. 2, the encoded audio and video streams are multiplexed and put into a container format. Finally, as illustrated in step 208 of FIG. 2, the processed audio content is subsequently sent over a WiFi wireless network to the destination device (e.g., television).

However, such additional real-time computations required to prepare and stream multimedia content for mirroring on another device may be taxing on the audio and video subsystems of a portable computing device. Portable computing devices are often required to run as efficiently as possible with a very low power consumption, and with audio and video subsystems confined to a small form factor that limits their computational capabilities and power requirements. Because of such limitations, the ability of a portable device to stream in real-time multimedia content (e.g., video game audio and video) may be taxed to the point that the delivered audio and video streams are not able to keep up in real-time with the multimedia content playing on the portable computing device if there are not enough processor cycles. At times when there are enough processor cycles, these audio and video subsystems must use the cycles efficiently to keep down the power consumption.

### SUMMARY OF THE INVENTION

Embodiments of this present invention provide solutions to the challenges inherent in real-time processing and encoding of an audio stream suitable for real-time mirroring on another device. In a method according to one embodiment of the present invention, a method for encoding audio is disclosed. The method for encoding audio comprises receiving a raw PCM audio signal and monitoring a user interface for user interface interaction events. The method continues by selecting one of a plurality of transform windows to hold a defined quantity of audio samples based upon a detected one or more user interface interaction events and associated transient information. The plurality of transform windows comprises a long window sequence comprising a single window with a first quantity of points or samples and a short window sequence comprising a plurality of second windows each comprising a second quantity of points or samples. A sum of points or samples of the plurality of second windows equals the first plurality of points or samples. The short window sequence is selected when a user interface interaction event is received from the user interface. The audio samples in the selected transform window are transformed and encoded.

In an apparatus according to one embodiment of the present invention, an audio system is disclosed. The audio system comprises an audio encoder which comprises a buffer comprising a plurality of transform windows, each operable to hold a defined quantity of audio samples. The audio encoder is operable to select one of the plurality of transform windows based upon one or more user interface interaction events and associated transient information. The plurality of transform windows comprises a long window sequence comprising a single window with a first quantity of points or samples and a short window sequence comprising a plurality of second windows each comprising a second quantity of points or samples. A sum of points or samples of the plurality of second windows equals the first plurality of points or samples. The audio encoder is further operable to select a short window sequence when a user interface interaction event is received from the user interface. The audio encoder is further operable to transform and encode the audio samples in the selected transform window.

### BRIEF DESCRIPTION OF THE DRAWINGS

Embodiments of the present invention will be better understood from the following detailed description, taken in conjunction with the accompanying drawing figures in which like reference characters designate like elements and in which:

FIG. 1 illustrates a simplified block diagram of a wireless network with a plurality of multimedia streaming and receiving devices;

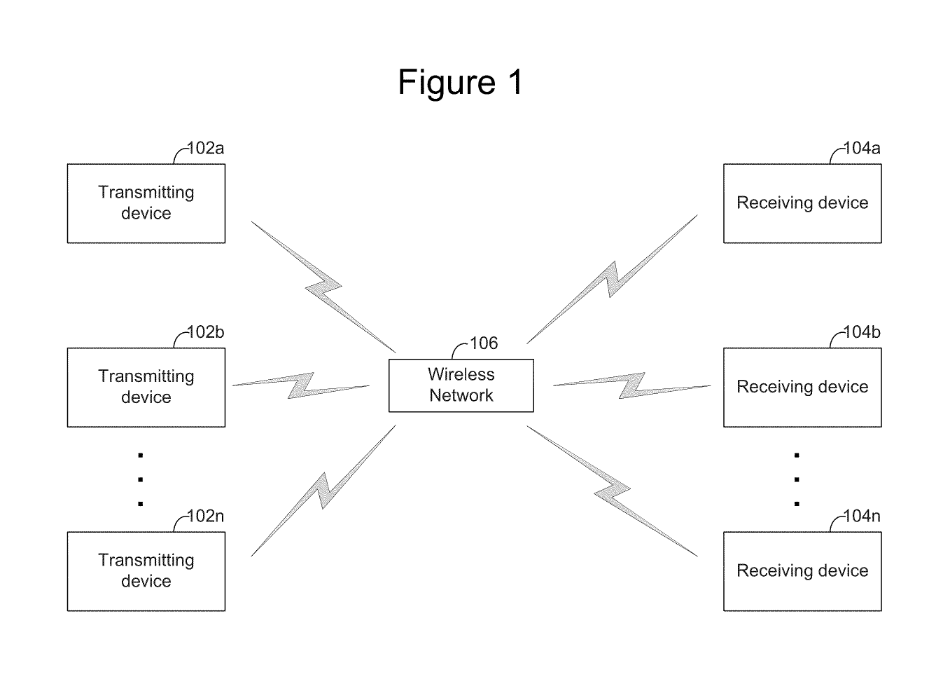

FIG. 2 illustrates a flow diagram illustrating exemplary steps to a process for capturing, encoding and streaming multimedia content in accordance with an embodiment of the present invention;

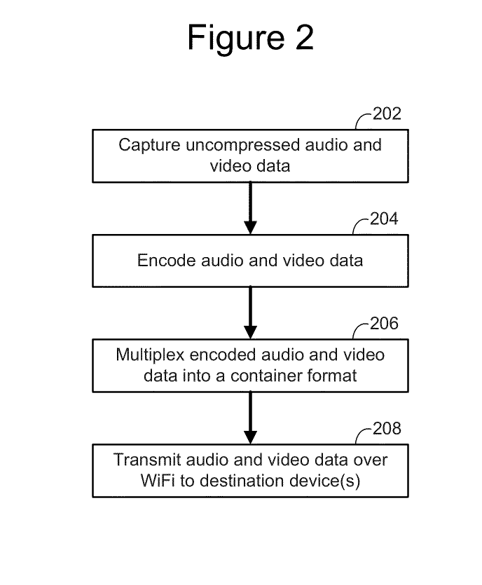

FIG. 3 illustrates a simplified block diagram of an exemplary audio encoder comprising a plurality of transform window sequence lengths, in accordance with an embodiment of the present invention;

FIG. 4 illustrates a flow diagram illustrating exemplary steps to a process for selecting a short window sequence when audio signal transients are detected in accordance with an embodiment of the present invention;

FIG. 5 illustrates a simplified block diagram of an exemplary audio encoder system in communication with a user interface for selecting an appropriate window sequence in response to cues received from the user interface in accordance with an embodiment of the present invention;

FIG. 6 illustrates a simplified block diagram of an exemplary audio system comprising an audio encoder in communication with an audio rendering subsystem operable to select stored pre-encoded or partially encoded audio signal in response to cues received from the audio rendering subsystem, in accordance with an embodiment of the present invention; and

FIG. 7 illustrates a simplified block diagram of an exemplary audio encoder system in communication with an audio rendering subsystem and a user interface in accordance with an embodiment of the present invention.

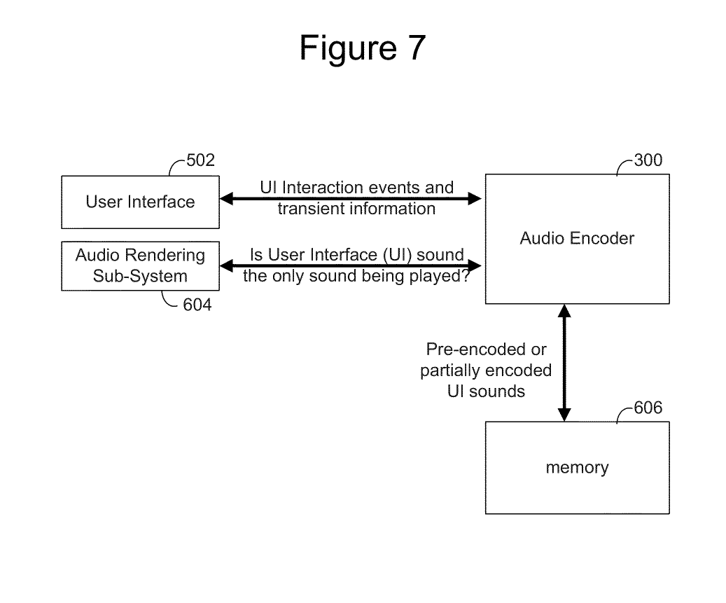

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Improving Audio Encoder Performance:

Embodiments of this present invention provide solutions to the challenges inherent in real-time encoding of an audio stream suitable for real-time mirroring on another device. Various embodiments of the present disclosure provide an apparatus and method where an exemplary audio encoder waits for cues from a user interface to aid in determining when an audio signal transient is expected. User Interface events like touch tones, gaming sounds etc. represent a sudden jump in sound level or a transient and when these cues are coming from the user interface, the audio encoder can decide to use the short transform directly to capture the transient. In such cases, the audio encoder need not execute a transient detection algorithm to detect transient or stationary signals. Using a short window sequence for transients helps in limiting the frequency transients in time domain for better reproduction of the transient. Whereas, when there are not any such cues from the user interface, executing the transient detection algorithms is necessary, as certain portions of the sound being played may have a transient, while certain other portions may be stationary.

These conditions may be detected with the transient detection mechanism of the audio encoder. In one embodiment, when cues from an audio rendering sub-system indicate that a UI sound, which is a pre-known sound, is the only sound being played, a pre-encoded or partially encoded audio signal may be pulled from a memory and incorporated into the encoded audio stream. This way, all or a major portion of the audio encoder processing may be bypassed.

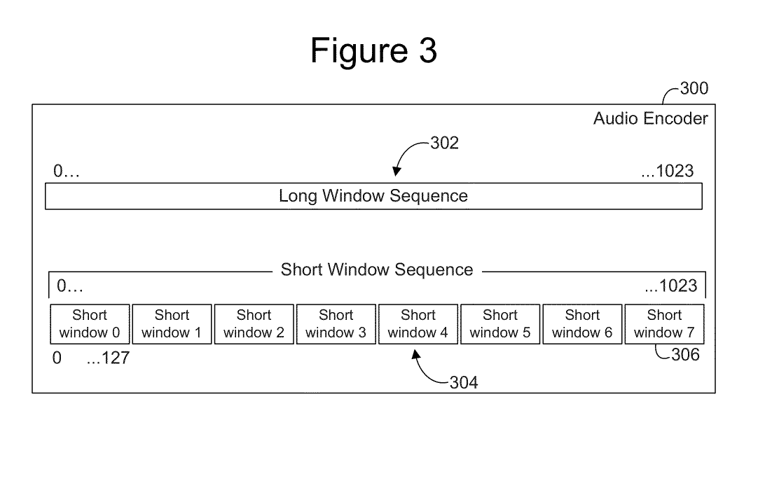

In one exemplary embodiment, audio encoder performance may be improved by advantageously giving the audio encoder system hints or cues about incoming audio signal transients. An audio transient is a sudden, short-duration spike in the audio signal amplitude. In one embodiment, to aid in capturing the audio signal during an audio signal transient, an AAC audio encoder (or any other audio encoder) that is used in Miracast systems may have multiple possible transform sample windows as illustrated in FIG. 3. An exemplary audio encoder 300 comprises a long window sequence 302 and a short window sequence 304. In one embodiment, an exemplary long window sequence 302 comprises 1024 points or samples, while an exemplary short window sequence 302 comprises eight short windows 306 of 128 points or samples each. Note that the sum of the points or samples of the eight short windows 306 equals the quantity of points or samples in the long window sequence 302. In other embodiments, the short and long window sequences may have other lengths.

In one embodiment, an exemplary audio encoder 300 converts an audio signal from time-domain to frequency-domain using a transform. In one exemplary embodiment, the transform is a forward modified discrete cosine transform (MDCT). Such a transform takes a desired number of time samples (as defined by the selected window length) and converts them into frequency samples. The resultant frequency domain signal may then be quantized and encoded.

As discussed herein, the short window sequence 304, illustrated in FIG. 3, may be used when a user interface cue indicates an audio signal transient, otherwise, a transient detection algorithm in the audio encoder 300 is executed, which analyses the audio signal. The transient detection algorithm will select the long window sequence 302 if there is no transient and the signal is stationary, otherwise, the transient detection algorithm will select the short window sequence 304. The use of the short window sequence 304 in capturing the audio signal and converting the audio signal from time-domain to frequency-domain ensures that audio transients are reproduced in the encoded audio stream faithfully. Meanwhile, the long window sequence 302 provides a high frequency resolution to the encoded audio stream otherwise.

Because the short window sequence 304, with a plurality of shorter windows 306 of reduced length, provides better temporal resolution when compared to the default long window sequence 302, the audio encoder 300 may switch windows to the plurality of short windows 306 when an audio signal transient has been detected. Similarly, because the long window sequence 302 has a sample window length an exemplary eight times longer than each of the short windows 306, the long window sequence 302 provides an increased frequency resolution, which allows efficient audio encoding.

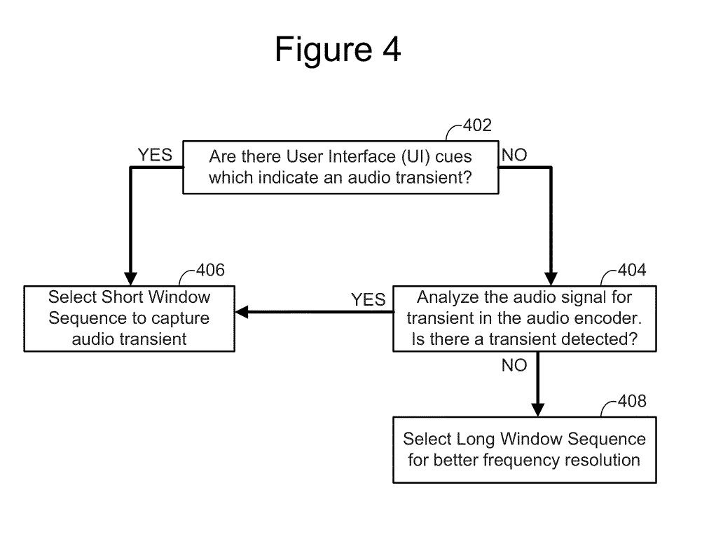

As illustrated in step 402 of FIG. 4, the short window sequence 304, comprising the plurality of short windows 306, will be selected when there is a user interface cue for an audio transient. As illustrated in step 404 of FIG. 4, when there is no user interface cue for an audio transient, the transient detection algorithm in the Audio Encoder 300 is executed, and if a transient is detected, then as illustrated in step 406 of FIG. 4, the short window sequence 304, comprising the plurality of short windows 306 is selected, and if there is no transient and the signal is stationary, then as illustrated in step 408 of FIG. 4, the long window sequence 302 is selected.

However, as already discussed, the real-time monitoring and encoding of some multimedia audio signals may tax the computational abilities of an exemplary audio encoder 300. Therefore, ways to improve the efficiency of audio encoder subsystems are desirable. As discuss herein, in one embodiment, audio encoding efficiency may be improved by providing the audio encoder 300 with user interface cues relating to user interface interactions that produce audio signal transients so that the short window sequence 304 may be efficiently and reliably selected to ensure the capture of audio signal transients resulting from such user interface interactions.

For example, when a portable device 102a-102n is used to play video games or receive streamed multimedia content, user interface (UI) interactions (e.g., using a touch pad, mouse or other UI inputs) may result in specific audio transients due to mixing of short duration sounds (e.g., touch tone sounds) onto a background audio, such as background music, etc. In other words, a specific UI interaction may result in a specific, repeatable, definable audio signal transient (e.g., a specific audio tone, such as a touch tone sound).

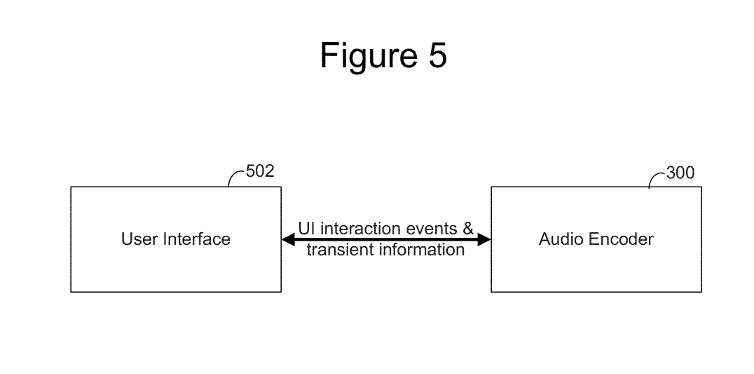

Such predictable and definable UI interaction-related audio signal transients may be communicated as cues to the audio encoder 300. Therefore, in one embodiment, illustrated in FIG. 5, the occurrence of audio signal transients related to UI interactions are communicated from the user interface 502 to the audio encoder 300. In one exemplary embodiment, the occurrence of UI interaction-produced audio signal transients may be communicated as UI interaction events to the audio encoder 300. Such that when a UI interaction event has been communicated from the user interface 502 to the audio encoder 300, the audio encoder 300 may select the short window sequence 304 for efficient sampling, transforming, and encoding of the audio signal transient.

As described herein, the transient cues provided by corresponding UI interaction events, where each UI interaction event may be related to a particular audio signal transient generated by an associated user interface interaction (e.g., a particular user interface interaction results in a particular touch tone sound), may be used to improve audio encoder 300 performance in a number of ways. Since a small window size is more efficient for localizing audio signal transients, the UI information may be used to switch the audio encoder 300 to short window sequences 304 when the audio signal transients occur. This may be useful in streaming or mirroring multimedia content such as video game audio when some user interface interaction results in a mixing of additional video game sounds. These video game sounds may also comprise predictable audio signal transients. In one embodiment, the communicated transient information includes audio signal transient duration.

Therefore, UI interaction events received by the audio encoder 300 from the user interface 502 may be used to preemptively switch the transform window selection to the short window sequence 304. In other words, rather than waiting for the audio encoder 300 to detect a audio signal transient from a UI interaction and switch the transform window selection to the short window sequence 304, the audio encoder 300 automatically switches to the short window sequence 304 in response to a received UI interaction event that indicates an expected audio signal transient.

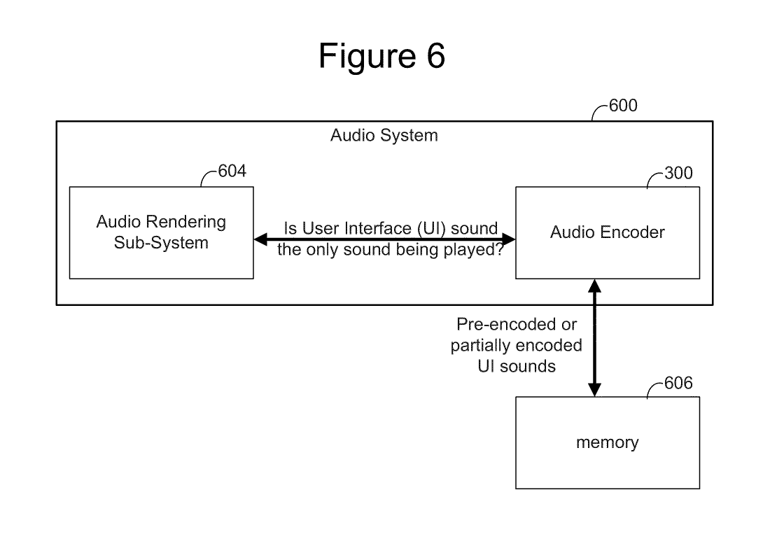

As illustrated in FIG. 6, the efficiency of audio encoding may be further improved by using pre-encoded or partially encoded UI interaction-produced sounds (like touch tone sounds) that result in audio signal transients. In one exemplary embodiment, the audio signal may comprise a plurality of sounds that are played simultaneously (e.g., video game sounds and UI interaction-produced sounds) and mixed to get a final sound. As discussed herein, when such combinations of UI interaction-produced audio signal transients mix with background sounds, the cues received from the user interface 502 may allow the audio encoder 300 to preemptively switch to the short window sequence 304. Furthermore, if at any time, UI interaction-produced touch tone sounds are the only sounds being played, then an audio rendering sub system 604, as illustrated in FIG. 6, can send cues to the audio encoder 300. In one embodiment, an exemplary audio rendering subsystem 604 is an audio rendering framework which is a part of an audio system 600 of portable computing devices 102a-102n (e.g., smart phones, tablets, and laptops) that receives all the audio streams that are currently being played and mixes them and renders the mixed audio stream to the audio hardware of portable computing devices 102a-102n. So the audio rendering subsystem 604 has the capacity to detect the number of audio streams being currently played and their sources like UI sounds, gaming sounds, music sounds etc. In one embodiment, as illustrated in FIG. 6, the memory 606 is located outside the audio system 600. In another embodiment, the memory 606 may be located within the audio system 600.

Since frequency characteristics and time durations of these UI interaction produced touch tone sounds are pre-known, and definable, they may be effectively used for encoding purposes. In one embodiment, pre-encoded and/or partially encoded UI interaction-produced sounds (e.g., touch tone sounds) may be stored in a memory 606 and later retrieved for injection into an encoded audio stream when a corresponding event indicating that a UI sound is the only sound being played is sent by the audio rendering sub system 604 to the audio encoder 300. For example, the transform and encoding blocks may be completely avoided in the encoding process when user interface interaction-produced sounds, with known frequency compositions, that have been pre-calculated, pre-encoded, and saved, are loaded from memory 606 and used. Using such explicitly available information will not only improve encoding efficiency, but may also significantly reduce encoder workloads as computationally demanding blocks may be bypassed, such as transient detection and frequency transformation in the encoding process.

In one embodiment, illustrated in FIG. 6, the audio encoder 300 may call for a particular saved pre-encoded or partially encoded user interface interaction-produced sound from the memory 606 when the audio rendering sub system 604 sends a cue to the audio encoder 300 that a UI sound which is a pre-known sound is the only sound being played currently.

The computational overhead for the audio encoder 300 may be improved by reducing the computation requirements because the audio encoder 300 does not have to dynamically determine that an audio signal transient has been detected (at least for UI interactions that result in audio signal transients). In one embodiment, the audio encoder 300 dynamically monitors an audio stream and determines whether it needs to use the short window sequence 304 or the long window sequence 302. In this case, part of the computation requirement can be reduced if the audio encoder 300 may be preemptively required to switch to a short window sequence 304 for an anticipated UI interaction-produced audio signal transient without requiring the audio encoder 300 to dynamically determine that the short window sequence 304 is required. This improves on the overall quality of the audio encoder 300 and also reduces the required computational complexity of the audio encoder 300. By receiving hints from the user interface 502, the audio encoder 300 does not have to determine if a short window sequence 304 is needed when UI interaction events from the user interface 502 are sent to the audio encoder 300.

Because the audio encoder 300 may rely upon UI interaction cues (UI interaction events) for determining whether or not a short window sequence 304 needs to be selected to process an audio signal transient, the audio encoder 300 does not need to take that time or those computational resources to determine if the short window sequence 304 needs to be selected. As described herein, exemplary embodiments also ensure that all UI interaction-produced audio signal transients are captured with short window sequences 304 (as discussed herein, otherwise, some might be missed or improperly or incompletely encoded).

The use of pre-encoded and partially encoded audio sounds stored for retrieval also provides many benefits. For example, the use of pre-encoded or partially encoded audio sounds for at least frequently used and typical UI interaction-produced sounds (e.g., touch tone sounds), ensures that when an audio signal from a UI interaction-produced sound has been triggered, the Audio Encoder 300 picks up a pre-encoded or a partially encoded sound from the Memory 606. This will save a lot of computational resources that the Audio Encoder 300 would have used had it decided to encode the raw Audio Stream.

Therefore, the processing of audio signal transients may be improved because the audio encoder 300 does not need to determine that an audio signal transient from a UI interaction-produced sound (e.g., touch tone sounds) has been detected, and further, if UI sounds are the only sounds being currently played, then the audio encoder 300 does not have to spend the time processing the audio signal and encoding the audio signal, since the audio encoder 300 can pull a pre-encoded version of the audio signal from memory.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. An audio system comprising:
an audio encoder comprising at least one buffer, wherein the buffer comprises:
a plurality of transform windows each operable to hold a defined quantity of audio samples, wherein the audio encoder is operable to select one of the plurality of transform windows based upon one or more user interface interaction events and associated transient information, wherein the plurality of transform windows comprises:
a long window sequence comprising a single window with a first quantity of samples; and
a short window sequence comprising a plurality of second windows each comprising a second quantity of samples, wherein a sum of samples of the plurality of second windows equals the first plurality of samples, wherein the audio encoder is further operable to select a short window sequence when a particular user interface interaction event is received from a user interface, and wherein the audio encoder is further yet operable to transform and encode the audio samples in the selected transform window.

2. The audio system of claim 1, wherein a transform window sequence comprises a forward modified discrete cosine transform (MDCT).

3. The audio system of claim 1, wherein the long window sequence comprises 1024 samples.

4. The audio system of claim 1, wherein each window of the plurality of second windows of the short window sequence comprises 128 samples.

5. The audio system of claim 1, wherein a user interface interaction event comprises at least one of the following:
touchpad interaction;
button press; and
keypad interaction.

6. The audio system of claim 1, wherein transient information comprises at least one of:
duration of user interface interaction event;
type of interaction event;
sound associated with interaction event; and
whether an audio signal transient is associated with a received UI interaction event.

7. The audio system of claim 1 further comprising:
a memory module comprising a plurality of pre-encoded audio sounds and a plurality of partially encoded audio sounds, wherein the pre-encoded audio sounds and the partially encoded audio sounds comprise at least touch tone sounds;
an audio rendering subsystem operable to detect audio streams currently being played and their sources; and
wherein the audio encoder is further operable to select matching pre-encoded or partially encoded audio sounds from the memory module when the audio rendering subsystem indicates that a user interface sound is the only sound being played.

8. A method for encoding audio comprising:
receiving an unencoded audio signal;
monitoring a user interface for user interface events;
selecting one of a plurality of transform windows to hold a defined quantity of audio samples based upon a detected one or more user interface interaction events and associated transient information, wherein the plurality of transform windows comprises:
a long window sequence comprising a single window with a first quantity of samples; and
a short window sequence comprising a plurality of second windows each comprising a second quantity of samples, wherein a sum of samples of the plurality of second windows equals the first plurality of samples, and wherein the short window sequence is selected when a particular user interface interaction event is received from the user interface; and
transforming and encoding the audio samples in the selected transform window.

9. The method of claim 8, wherein a transform window sequence comprises a forward modified discrete cosine transform (MDCT).

10. The method of claim 8, wherein the long window sequence comprises 1024 samples.

11. The method of claim 8, wherein each window of the plurality of second windows of the short window sequence comprises 128 samples.

12. The method of claim 8, wherein a user interface interaction event comprises at least one of the following:
touchpad interaction;
button press; and
keypad interaction.

13. The method of claim 8, wherein transient information comprises at least one of:
duration of user interface interaction event;
type of interaction event;
sound associated with interaction event; and
whether an audio signal transient is associated with a received UI interaction event.

14. The method of claim 8 further comprising:
selecting a matching pre-encoded or partially encoded audio sound from a memory module when a user interface sound is the only sound being played, wherein the memory module comprises a plurality of pre-encoded audio sounds and a plurality of partially encoded audio sounds, and wherein the plurality of pre-encoded audio sounds and the plurality of partially encoded audio sounds comprise at least touch tone sounds.

15. An audio system comprising:
means for receiving an unencoded audio signal;
means for monitoring a user interface for user interface events; and
means for selecting one of a plurality of transform windows to hold a defined quantity of audio samples based upon a detected one or more user interface interaction events and associated transient information, wherein the plurality of transform windows comprises:
a long window sequence comprising a single window with a first quantity of samples; and
a short window sequence comprising a plurality of second windows each comprising a second quantity of samples, wherein a sum of samples of the plurality of second windows equals the first plurality of samples, and wherein the short window sequence is selected when a particular user interface interaction event is received from the user interface; and
means for transforming and encoding the audio samples in the selected transform window.

16. The audio system of claim 15, wherein a transform window sequence comprises a forward modified discrete cosine transform (MDCT).

17. The audio system of claim 15, wherein the long window sequence comprises 1024 samples.

18. The audio system of claim 15, wherein each window of the plurality of second windows of the short window sequence comprises 128 samples.

19. The audio system of claim 15, wherein a user interface event comprises at least one of the following:
touchpad interaction;
button press; and
keypad interaction.

20. The audio system of claim 15, wherein transient information comprises at least one of:
duration of user interface interaction event;
type of interaction event;
sound associated with interaction event; and
whether an audio signal transient is associated with a received UI interaction event.

21. The audio system of claim 15 further comprising:
means for selecting a matching pre-encoded or partially encoded audio sound from a memory module when a user interface sound is the only sound being played, wherein the memory module comprises a plurality of pre-encoded audio sounds and a plurality of partially encoded audio sounds, and wherein the plurality of pre-encoded audio sounds and the plurality of partially encoded audio sounds comprise at least touch tone sounds.
